(19) United States
(12) Patent Application Publication
(10) Pub. No.: US 2024/0099505 A1
(43) Pub. Date: Mar. 28, 2024

(54) SYSTEM FOR PRODUCING DISTINCTIVE FOOD OBJECTS

(71) Applicant: Instant Brands Holdings Inc., Downers Grove, IL (US)

(72) Inventor: Jason LePinske, Schaumburg, IL (US)

(73) Assignee: Instant Brands Holdings Inc., Downers Grove, IL (US)

(21) Appl. No.: 18/452,654

(22) Filed: Aug. 21, 2023

Related U.S. Application Data
(60) Provisional application No. 63/410,058, filed on Sep. 26, 2022.

(51) Int. Cl. A47J 36/16; A23P 30/10; A47J 43/20

(52) U.S. Cl. CPC A47J 36/16; A23P 30/10; A47J 43/20

(57) ABSTRACT

An insert for a pressure cooker has a single contiguous insert body with a top surface, a bottom surface and a periphery. The insert is able to be placed within the pressure cooker such that the periphery is substantially flush with an inner sidewall of the pressure cooker. Tessellated cavities are formed within the insert body, with each cavity having a substantially polygonal cross-section parallel to the top surface.

### RELATED APPLICATION

This application claims the benefit of U.S. Provisional Patent Application No. 63/410,058, filed Sep. 26, 2022, the entirety of which is herein incorporated by reference.

### FIELD OF THE DISCLOSURE

The disclosed embodiments relate to food cooking systems, devices and apparatuses.

### BACKGROUND OF THE DISCLOSURE

Molds for producing individually portioned food products are known in the art. Some such foods are commonly known as egg-bites, cake-bites, mini-muffins, mini-brownies, meatloaf minis, or the like. The molds for producing such “mini” food items commonly come in the form of metal or silicone baking trays with rows and columns of individual spherical or cylindrical cups in which the uncooked food is held for cooking.

However, these prior art molds are generally not designed for use within pressure cooking systems. Moreover, even where molds are designed for use within pressure cooking systems, the resulting “mini” food products are aesthetically unpleasing and/or are structurally unsound. In particular, such molds produce tall, narrow dome shaped food products that are unstable, easily topple over, and generally fall apart when cut into. In addition, such molds generally produce food products with a pronounced domed surface that is unsuitable as a base for supporting the food product. This necessitates that the open-side of the mold shape the base of the food product, which limits the mold's ability to effectively accommodate garnishes, etc., applied to the open side, as such garnishes would then be under the food product and not visible on top of the food product. The resulting aesthetic and structural deficiencies of the food products produced by the prior art molds means that consumers are less likely to adopt those molds and/or food products.

In addition, such molds generally do not result in an efficient use of the available space, while also producing aesthetically pleasing and structurally sound food products. Indeed, the capacity of these prior art molds fails to allow for the cooking of pre-packaged food mixes (e.g., cake mix, etc.) without resulting in too much or too little mix, particularly with respect to pre-packaged food mixes intended for 8-inch round pans. Moreover, merely increasing/decreasing cup size results in structurally unsound food products. That is, the resulting food products may be undercooked or may be shaped in a way that they are prone to toppling over or otherwise falling apart.

A system is therefore proposed in which an insert for a pressure cooker provides advantages heretofore unrealized by the prior art, including but not limited to the production of molded food products has a body structure that produces interesting, aesthetically pleasing, structurally sound, and volumetrically efficient shape.

### SUMMARY OF THE DISCLOSURE

The system is directed to an insert for a pressure cooker. The insert includes a single contiguous insert body having a top surface, a bottom surface and a periphery. The insert is configured to be placed within the pressure cooker such that the periphery is substantially flush with an inner sidewall of the pressure cooker. A plurality of tessellated cavities is formed within the insert body. Each cavity has a substantially polygonal cross-section parallel to the top surface.

The system may further include a lid. The lid has a lid body that covers the insert while in use within the pressure cooker. A lid rim extends from the lid body to securely snap-fit the lid body to the insert at the insert periphery. The lid body has a plurality of domes that each cover a corresponding cavity when the lid is placed on the insert. The lid allows for venting of the insert.

Accordingly, the molded food product resulting from use of the system may have an interesting, aesthetically pleasing, structurally sound, and/or volumetrically efficient shape when compared to molded food products produced by other means.

Other features and advantages of the present disclosure will become apparent from the following more detailed description, taken in conjunction with the accompanying drawings, which illustrate, by way of example, the principles of the disclosure.

### BRIEF DESCRIPTION OF THE SEVERAL VIEWS OF THE DRAWING(S)

FIG. 1 is a top perspective view of an insert for a pressure cooker according to at least one embodiment of the disclosure.

FIG. 2 is a bottom perspective view of the insert according to at least one embodiment of the disclosure.

FIG. 3 is a top plan view of the insert according to at least one embodiment of the disclosure.

FIG. 4 is a side view of the insert according to at least one embodiment of the disclosure.

FIG. 5 is a top perspective view of a cavity of the insert separate from the insert according to at least one embodiment of the disclosure.

FIG. 6 to perspective view of the insert and a lid according to at least one embodiment of the disclosure.

### DETAILED DESCRIPTION OF THE PREFERRED EMBODIMENTS

The above described drawing figures illustrate the disclosure in at least one embodiment, which is further defined in detail in the following description. Those having ordinary skill in the art may be able to make alterations and modifications to what is described herein without departing from its spirit and scope. While the disclosure is susceptible of embodiment in many different forms, there is shown in the drawings and will herein be described in detail at least one preferred embodiment with the understanding that the present disclosure is to be considered as an exemplification of the principles discussed herein and is not intended to limit the broad aspect of the disclosure to the embodiments illustrated. Therefore, it should be understood that what is illustrated is set forth only for the purposes of example and should not be taken as a limitation on the scope of the disclosure.

FIGS. 1-4 schematically illustrate an insert 100 for a pressure cooker according to at least one embodiment. As shown in FIG. 1, the insert 100 comprises a body 110 having a top surface 200 formed opposite a bottom surface 300 and connected thereto by an insert periphery 400. The body is preferably shaped such that the insert 100 may be readily placed into a cooking basin of a pressure cooker with the insert periphery 400 being slideably flush with an interior wall defining the cooking basin.

The insert body 110 may be formed of molded silicone and/or any other food-safe material. As used herein, the term “food-safe material” refers to materials or compositions that are suitable for the uses described herein without creating a food-safety hazard. In particular, the insert 100 may be used to cook food therein when placed into the cooking basin of the pressure cooker, such as the pressure cooker disclosed in U.S. application Ser. No. 16/661,248, filed on Oct. 23, 2019, the entire contents of which are incorporated herein by reference.

A plurality of cavities 210 may be formed in the top surface 200, so as to extend from the top surface 200 towards the bottom surface 300. The cavities 210 may be dimensioned so as to receive food therein for cooking via the pressure cooker. In particular, the cavities 210 may be dimensioned so as to produce a molded food product, such as an egg-bite, cake-bite, muffin, brownie, meatloaf mini, or the like, where the molded food product has an improved interesting, aesthetically pleasing, structurally sound, and volumetrically efficient shape. In some embodiments, each cavity 210 has an interior volume of approximately between 27.6 cubic millimeters and 77.3 cubic milliliters, preferably approximately 70.7 cubic millimeters. The insert 100 preferably has seven cavities 210, although more or fewer cavities 210 may be provided.

In some embodiments, the cavities 210 are configured to produce the molded food product shaped to be less prone to toppling over and generally falling apart when cut into, which shape is defined by the shape of the cavities 210. In particular, the molded food product is produced by the mold to have a gem-like shape with several faceted surfaces, as well as roughly parallel top and bottom surfaces. This gem-like shape provides for improved structural integrity that is less prone to toppling over or falling apart when cut into. The gem-like shape also provides the molded food product with the structural stability to be placed in either upside-down or right-side-up orientations without collapsing or toppling over in either. Moreover, the resulting shape of the molded food product allows for garnishes to be placed on top of the molded food product with a reduced likelihood of falling off, as compared to molded food products produced by prior art molds. In some embodiments, the gem-like shape produced by the cavities 210 may be a squat gem-like shape, which may enhance the aforementioned benefits of the gem-like shaped molded food product. Further discussion of the cavities 210 configured to produce the gem-like shape is had below.

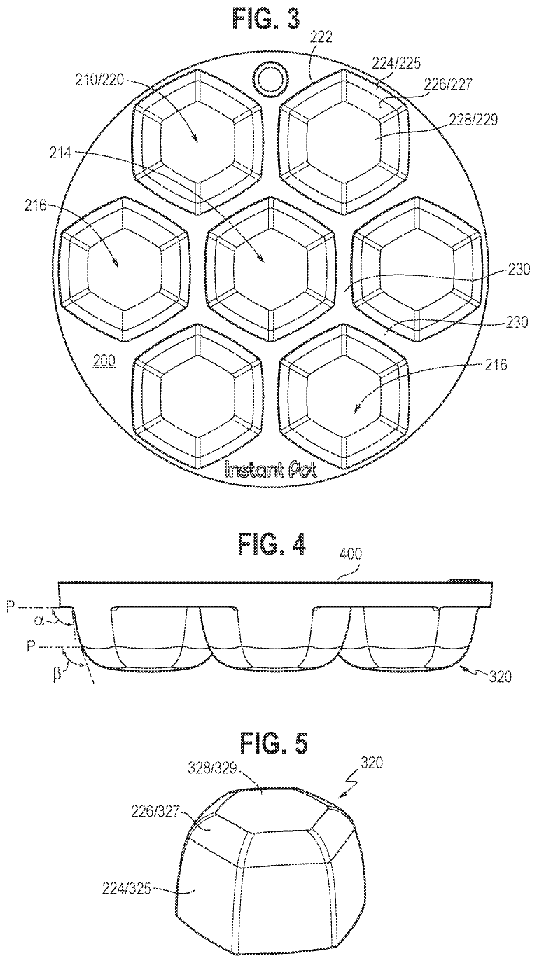

As shown in FIG. 3, each cavity 210 may be formed of top edges 222, upper sidewalls 224, lower sidewalls 226 and a cavity floor 228, defining a cavity interior 220.

The top edges 222 of each cavity 210 may form a cavity periphery that joins the cavity 210 to the top surface 200. The cavity periphery may be polygonal in shape, with each of the top edges 222 forming a respective side of the polygonal shape. For example, the cavity periphery may be hexagonal, with six top edges 222 forming the respective sides of the hexagon. In some embodiments, the top edges 222 may be slightly bowed outwards so that the cavity periphery is not strictly polygonal, but is rather substantially polygonal.

Each upper sidewall 224 may extend from a respective top edge towards a respective lower sidewall 226, whereas each of the lower sidewalls 226 may, in turn extend from a respective upper sidewall 224 towards the cavity floor 228. Accordingly, the cavity periphery, upper sidewalls 224, lower sidewalls 226 and cavity floor 228 may abut so as to together define the interior volume of the cavity 210.

Moreover, the upper and lower sidewalls 226 of the cavity 210 may comprise inner surfaces 225, 227 that are concave. In some embodiments, the cavity floor 228 may also comprise a floor inner surface 229 that is likewise concave. The cavity floor 228 may further be polygonal in shape, so as to be consistent with the cavity periphery. Accordingly, the cavity 210 may have a substantially polygonal cross-section in planes parallel to the top surface 200.

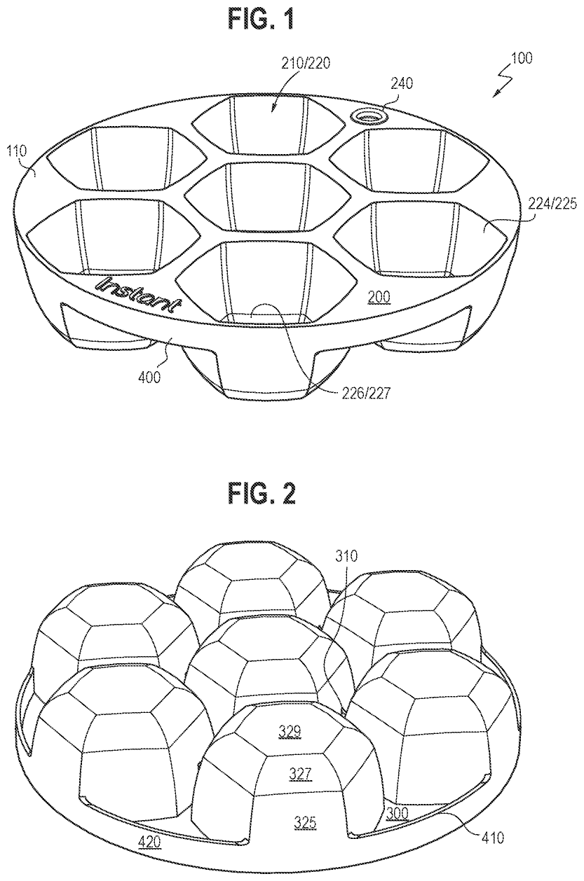

Turning to FIG. 2, the bottom surface 300 of the insert 100 may include, for each cavity 210, a cavity exterior 320 that extends from the bottom surface 300 away from the top surface 200. The cavity exterior may comprise corresponding outer surfaces 325, 327, 329 of the upper sidewalls 224, the lower sidewalls 226 and the cavity floor 228, respectively. The outer surfaces may be convex so as to match with the concave inner surfaces. FIG. 5 schematically shows the cavity exterior as separate from the rest of the insert 100.

In at least one embodiment, the shape of each of the sidewalls corresponds to a spherical rectangle. In particular, the spherical rectangle may be that of a sphere with a diameter of 180 mm, although other diameters may be used without departing from the principles of the disclosure. The upper sidewall 224 may correspond to a first spherical rectangle oriented inward at a first angle α with respect to a plane P of the top surface 200. The lower sidewall 226 may correspond to a second spherical rectangle oriented inward at a second angle (3 that is between the first angle α and the plane P of the top surface 200. The first angle α and the second angle (3 are schematically shown in FIGS. 4 and 5. As also shown in FIG. 4, the cavity floor 228 may be substantially parallel to the plane P of the top surface 200. In some embodiments, the cavity floor 228 may correspond to a spherical polygon of the sphere. Accordingly, the interior volume of each cavity 210 is dimensioned so as to produce the molded food product having an interesting, aesthetically pleasing, structurally sound, and/or volumetrically efficient shape.

As shown in FIG. 3, in at least one embodiment, the plurality of cavities 210 may be arranged within the insert 100 in a tessellated arrangement 212. In particular, the tessellated arrangement 212 may be a honeycomb arrangement of the cavities 210. Moreover, the tessellated arrangement 212 may be such that the plurality of cavities 210 comprise peripheral cavities 214 surrounding a central cavity 216. The tessellated arrangement 212 further may be such that one or more graspable ridges 230 may be formed by the top surface 200 between adjacent edges of two or more of the cavities 210. The graspable ridges 230 are preferably configured so that the insert 100 may be lifted out of the cooking basin of the pressure cooker by the graspable ridges 230.

Turning back to FIG. 2, the bottom surface 300 may further include one or more ribs 310 connecting adjacent cavities 210 at their respective exteriors 320. The ribs 310 are preferably structural support ribs that are of sufficient dimension and structural rigidity to keep the top surface 200 substantially unbowed despite the presence of the cavities 210. Accordingly, one or more of the ribs 310 may span between the exterior surfaces 325 of near upper sidewall 224 of adjacent cavities 210, as shown in FIG. 2.

As noted herein, the bottom surface 300 may be connected to the top surface 200 via the insert periphery 400. In at least one embodiment, the insert periphery 400 forms a peripheral ridge 410 that provides structural rigidity to the insert 100. The insert periphery 400 further includes a peripheral surface 420 that is slideably flush with the interior wall of the cooking basin when the insert 100 is placed within the cooking basin of the pressure cooker. Accordingly, the peripheral surface 420 may be a substantially circular ring that abuts the interior wall.

The peripheral surface 420 further may be shaped as a latitudinal band of the sphere according to which the sidewalls 222, 224, 226 are shaped. Accordingly, the peripheral surface 420 (and thus the insert body 110) preferably has a diameter of approximately 180 mm. The peripheral surface 420 may therefore be contiguous with at least one of the upper sidewalls 224. The peripheral surface 420 is also preferably continuous with at least upper sidewall 224 of each peripheral cavity 214, namely, the radially outward most upper sidewall 224 of each peripheral cavity 214. Accordingly, the latitudinal band may extend seamlessly into the most radial upper sidewalls 224 of each peripheral cavity 214.

It will be understood that, while the insert body 110 is described herein as having a diameter of 180 mm, the insert body 110 may be produced with a greater or lesser diameter as necessary to accommodate cooking basins of various diameters (e.g., 8.0 in, 8.5 in, 9.25 in). A skilled artisan will understand that the sphere dimensions according to which the upper sidewalls 224, lower sidewalls 226, cavity floors 228, and the peripheral surface 420 are curved may also be sized for similar accommodation.

Turning back to FIG. 1, the insert 100 may also include at least one eyelet 240 extending through the top surface 200 adjacent the insert periphery 400. The eyelet 240 may be configured as a vent to allow steam or other gaseous flow through the eyelet 240 during use within the pressure cooker. The eyelet 240 further may be dimensioned so as to allow a user's finger (or other similarly sized tool) to be at least partially inserted into the eyelet 240 for gripping and thereby pulling out the insert 100 from within the pressure cooker cooking basin.

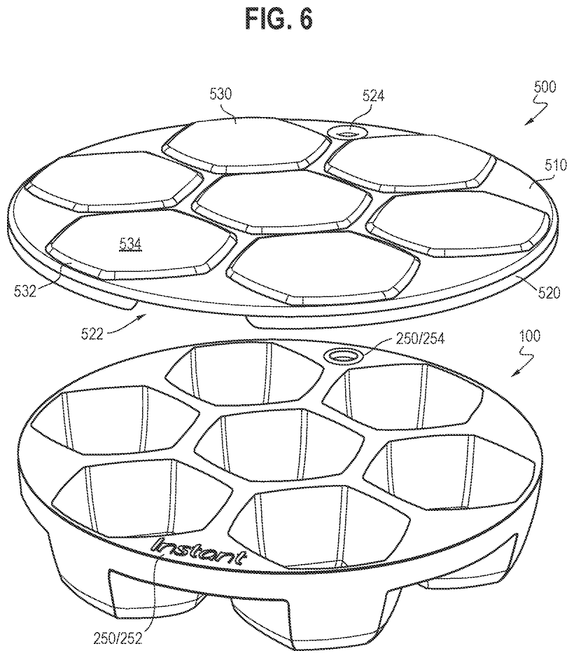

As shown in FIG. 6, in some embodiments, a system for the pressure cooker may comprise the insert 100 described herein and a lid 500 that is configured to cover the insert 100 while in use within the pressure cooker. The lid 500 may be likewise formed of molded silicone and/or any other food-safe material.

The lid 500 may comprise a lid body 510 and a lid rim 520 that is dimensioned to securely snap-fit to the insert periphery 400. The lid body 510 indeed preferably has a size and shape to match that of the top surface 200, so that, when in use, the lid rim 520 extends around the entire insert periphery 400 so as to form a seal therewith.

The lid rim 520 may also include one or more vents 522 configured to allow for gaseous flow from the cavities 210 to outside the insert 100. The vents may be formed by portions of the lid 500 where there is no lid rim 520, or where there is insufficient lid rim 520 to form the seal. In some embodiments, particularly when in use with the lid 500, the top surface 200 may also include one or more raised portions 250 configured to separate the top surface 200 from the lid 500 placed on top of the top surface 200, so as to provide venting for the cavities 210 and thereby prevent a vacuum seal from forming between the lid 500 and the top surface 200. Accordingly, gaseous flow may be had between the cavities 210 and/or from the cavities 210 to outside the insert 100.

The raised portions 250 may be integrated into other structural elements of the insert 100, or may be independent thereof. For example, as shown in FIG. 1, a first raised portion 252 may form a company logo or other decorative element on the top surface 200, whereas a second raised portion 254 may form a ring around the eyelet. Other raised portions (not shown) may include, but are not limited to: spaced ridges encircling cavity peripheries, bumps or other textures covering the top surface 200, and ridges connecting adjacent cavities 210.

The lid body 510 may also include a hole 524 corresponding to the eyelet 240 of the insert 100. The hole 524 may extend through the lid body 510 so as to maintain the aforementioned functions associated with the eyelet 240. In particular, the hole 524 may be configured to allow gaseous flow through the eyelet 240 and the hole 524, as well as to allow the user's finger (e.g., pinky) to be inserted through the eyelet 240 and the hole 524 for removal of the insert 100.

The lid body 510 may further include one or more domes 530, each dome 530 corresponding to one of the cavities 210 of the insert 100. Accordingly, the domes 530 may be arranged within the lid body 510 so as to cover the corresponding cavity 210 of the insert 100 when the lid 500 is placed on the insert 100. Each dome 530 may be configured to provide additional space between any food contents of the cavity 210 and the lid 500, so as to mitigate food contacting the lid 500 during use. Accordingly, each dome 530 may comprise one or more sidewalls 532 supporting a raised surface 534 from the lid body 510.

The embodiments described herein are useful for producing the molded food product (not shown) with the pressure cooker. In particular, the molded food product may have an interesting, aesthetically pleasing, structurally sound, and/or volumetrically efficient shape when compared to molded food products produced by other means.

The embodiments described in detail herein are thus considered novel over the prior art of record and are considered critical to the operation of at least one aspect of the disclosure and to the achievement of its objectives. The words used in this specification to describe the embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventor believes that the claimed subject matter is what is intended to be patented.

What is claimed is:

1. An insert for a pressure cooker, the insert comprising:
a single contiguous insert body having a top surface, a bottom surface and a periphery, configured to be placed within the pressure cooker such that the periphery is substantially flush with an inner sidewall of the pressure cooker;
a plurality of tessellated cavities formed within the insert body, wherein each cavity has a substantially polygonal cross-section parallel to the top surface.

2. The insert of claim 1, wherein each cavity has a substantially hexagonal cross-section parallel to the top surface.

3. The insert of claim 1, wherein the plurality of cavities is exactly seven cavities.

4. The insert of claim 1, wherein each cavity defines an interior volume between 27.6 millimeters and 77.3 milliliters.

5. The insert of claim 1, wherein each cavity is defined by a plurality of upper sidewalls that each extend from the top surface so as to connect to corresponding lower sidewalls, the lower sidewalls in turn extending from the upper sidewalls so as to connect to a common floor of the cavity.

6. The insert of claim 5, wherein the upper sidewalls and the lower sidewalls are curved according to spherical rectangles of a sphere with a diameter of 180 mm.

7. The insert of claim 6, wherein the periphery comprises a peripheral surface that is curved according to a latitudinal band of the sphere.

8. The insert of claim 5, wherein the upper sidewalls each extend from the top surface at a first angle with respect to a plane of the top surface, wherein the lower sidewalls each extend from the upper sidewalls at a second angle with respect to the plane of the top surface, and wherein the second angle is between the first angle and the plane of the top surface.

9. The insert of claim 1, further comprising an eyelet through the insert body adjacent the periphery, wherein the eyelet is configured to receive a user's finger therein so as to enable the user to thereby lift the insert out of the pressure cooker.

10. The insert of claim 1, wherein the bottom surface includes one or more ribs connecting adjacent cavities at respective exteriors thereof.

11. A food molding system for a pressure cooker, the system comprising:
an insert comprising:
a single contiguous insert body having a top surface, a bottom surface and a periphery, configured to be placed within the pressure cooker such that the periphery is substantially flush with an inner sidewall of the pressure cooker; and
a plurality of tessellated cavities formed within the insert body, wherein each cavity has a substantially polygonal cross-section parallel to the top surface; and
a lid comprising:
a lid body configured to cover the insert while in use within the pressure cooker;
a lid rim extending from the lid body and configured to securely snap-fit the lid body to the insert at the insert periphery; and
a plurality of domes arranged within the lid body so as to each cover a corresponding cavity when the lid is placed on the insert.

12. The system of claim 11, wherein the top surface of the insert includes one or more raised portions that maintain separation between the top surface and the lid.

13. The system of claim 11, wherein the raised portions comprise a decorative element on the top surface.

14. The system of claim 11, wherein the lid rim includes at least one vent via which gaseous flow is enabled between the cavities and the exterior of the insert.

15. The insert of claim 11, wherein each cavity has a substantially hexagonal cross-section parallel to the top surface.

16. The insert of claim 11, wherein each cavity defines an interior volume between 27.6 millimeters and 77.3 milliliters.

17. The insert of claim 11, wherein each cavity is defined by a plurality of upper sidewalls that each extend from the top surface so as to connect to corresponding lower sidewalls, the lower sidewalls in turn extending from the upper sidewalls so as to connect to a common floor of the cavity.

18. The insert of claim 17, wherein the upper sidewalls and the lower sidewalls are curved according to spherical rectangles of a sphere with a diameter of 180 mm.

19. The insert of claim 18, wherein the periphery comprises a peripheral surface that is curved according to a latitudinal band of the sphere.

20. The insert of claim 17, wherein the upper sidewalls each extend from the top surface at a first angle with respect to a plane of the top surface, wherein the lower sidewalls each extend from the upper sidewalls at a second angle with respect to the plane of the top surface, and wherein the second angle is between the first angle and the plane of the top surface.
